(19) United States
(12) Patent Application Publication
(10) Pub. No.: US 2016/0256954 A1
(43) Pub. Date: Sep. 8, 2016

(54) METHOD AND SYSTEM FOR DIFFUSION BONDED COMPONENTS HAVING INTERNAL PASSAGES

(71) Applicant: UNITED TECHNOLOGIES CORPORATION, Hartford, CT (US)

(72) Inventor: Santiago Lattanzio, Manchester, CT (US)

(21) Appl. No.: 15/027,639

(22) PCT Filed: Sep. 25, 2014
(86) PCT No.: PCT/US14/57500

§ 371 Date: Apr. 6, 2016

Related U.S. Application Data
(60) Provisional application No. 61/889,026, filed on Oct. 9, 2013.

(51) Int. Cl. B23K 20/02; F04D 29/64; F04D 29/38

(52) U.S. Cl. CPC B23K 20/02; F04D 29/388; F04D 29/644; F05D 2220/36; F05D 2230/236; B23K 2201/001

(57) ABSTRACT

A method for making a metallic component includes placing a diffusion bonded airfoiled component having an initial shape into a first intermediate shaping die. The first intermediate shaping die has a cavity corresponding to a first intermediate shape different from the initial shape. The component is shaped into the first airfoil shape by applying a first elevated temperature to the first intermediate shaping die. The component is transferred into a final shaping die, which has a cavity corresponding to a target nominal shape different from the first intermediate shape and the initial shape. The component is shaped into a final nominal shape substantially equivalent to the target nominal shape by applying a final elevated temperature to the final shaping die.

### BACKGROUND

The disclosed subject matter relates generally to hollow components and more particularly to components formed at least in part by diffusion bonding.

A hollow component can be made by diffusion bonding two or more elements together and forcing the joined elements to conform to a mold. Depending on the initial shape of the elements, the component may have a shape far different from the desired shape of the finished part.

With the drive to improve efficiency, highly cambered or twisted components are provided with internal geometric features. To shape the component according to these or other design considerations, the diffusion bonded component is placed directly into a heated shaping die corresponding to the desired shape of the finished part. However, existing bulk shaping processes which add twist, camber, and/or other three dimensional shape often result in deviation of the internal geometry and can cause high scrap rates.

It has been attempted to shape diffusion bonded components through various cold-working processes. However, these earlier processes introduce unnecessary complexity and can leave residual stresses in the component, while still having an elevated risk of internal geometry deformation.

### SUMMARY

A method for making a metallic component includes placing a diffusion bonded component having an initial shape into a first intermediate shaping die. The first intermediate shaping die has a cavity corresponding to a first intermediate shape different from the initial shape. The component is shaped into the first intermediate shape by applying a first elevated temperature to the first intermediate shaping die. The component is transferred into a final shaping die. The final shaping die has a cavity corresponding to a target nominal shape different from the first intermediate shape and the initial shape. The component is shaped into a final nominal shape substantially equivalent to the target nominal shape by applying a final elevated temperature to the final shaping die.

A system for processing a metallic component includes a first intermediate shaping die adapted to receive a diffusion bonded metallic component having an initial shape and an internal geometry. A first intermediate shaping unit is adapted to facilitate a first stage of a bulk shaping process by receiving and elevating the temperature of the first intermediate shaping die. A final shaping die is adapted to receive the diffusion bonded component after the first stage of the bulk shaping process. A final shaping unit is adapted to facilitate a final stage of the bulk shaping process by receiving and elevating the temperature of the final shaping die.

### BRIEF DESCRIPTION OF THE DRAWINGS

FIG. 1 is a method for making and bulk shaping a metallic component with hollow internal geometry.

FIG. 2 schematically depicts an example production system for making and bulk shaping a metallic component with hollow internal geometry.

FIG. 3A shows an example mold for superplastic forming/diffusion bonding (SPF/DB) elements into a fan blade with an initial airfoil shape.

FIG. 3B is a sectional view of the fan blade formed into an initial airfoil shape by the mold shown in FIG. 3A.

FIG. 4A shows a first intermediate shaping die for bulk shaping the fan blade of FIG. 3B into a first intermediate airfoil shape.

FIG. 4B is a sectional view of the fan blade formed into the first intermediate airfoil shape by the first intermediate shaping die shown in FIG. 4A.

FIG. 5A shows a final shaping die for bulk shaping the fan blade of FIG. 4B into a final nominal airfoil shape.

FIG. 5B is a sectional view of the fan blade formed into a final airfoil shape by the final shaping die shown in FIG. 5A.

### DETAILED DESCRIPTION

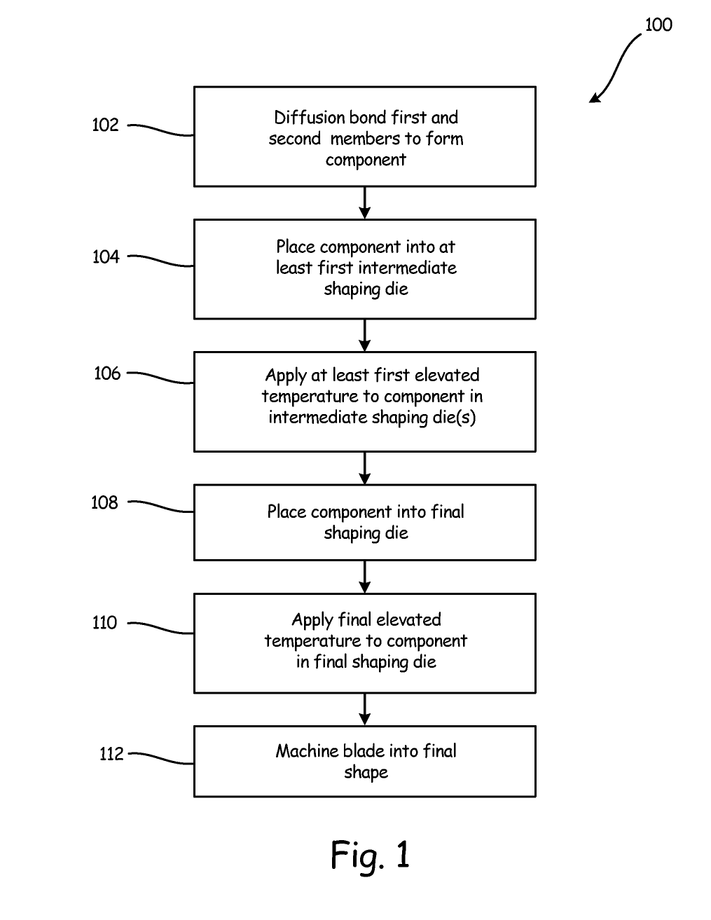

FIG. 1 shows method 100 for making and bulk shaping a metallic component having hollow internal geometry (for example, one or more internal passages or cavities separated by internal ribs). The metallic component can be formed using a diffusion bonding process, and is then subjected to bulk shaping so as to produce a twisted and/or cambered component while substantially maintaining the integrity of the internal geometry. The component can be formed at least in part by diffusion bonding two elements as shown in step 102. Alternatively, the metallic component can be diffusion bonded then subjected to a separate bulk shaping process.

The subject matter is described with reference to an airfoil shaped component such as a hollow fan blade for a turbofan engine. However, it will be appreciated that the subject matter can be readily adapted to other diffusion bonded components for turbine engines, as well as for uses outside the realm of turbine engines. For example, first and second airfoil members can have more general first and second component members substituted therefor.

Diffusion bonding is a well-known process which, in combination with superplastic deformation, can be used to make complex titanium and nickel alloy blades as an alternative for investment casting. Existing forming and shaping processes can be limited in their ability to reliably form highly cambered or twisted components while also substantially maintaining the target shape of internal geometry and ribs. Due to the high degree of added twist or camber, and vagaries of current forming and shaping processes, diffusion bonded blades, vanes and other components (with or without airfoils) can end up with the shape of any internal geometry being distorted (e.g., with narrowed or blocked cross-sections).

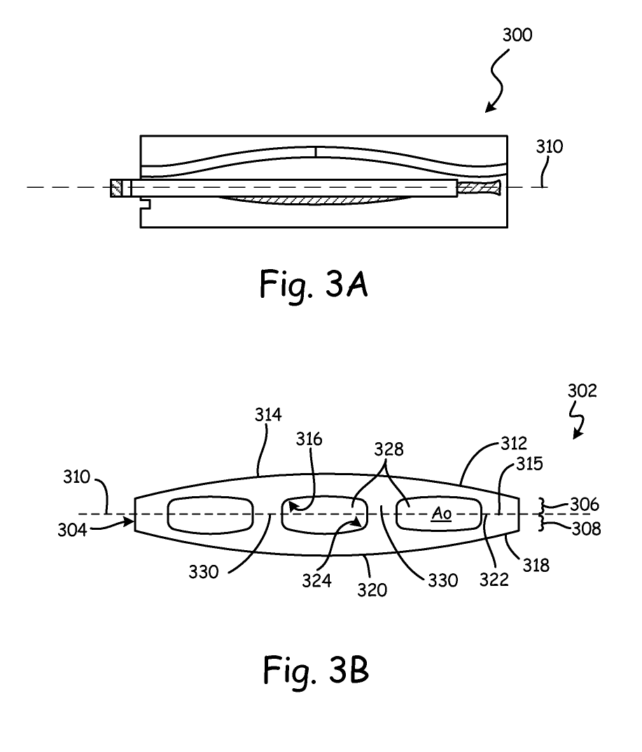

Method 100 begins with step 102, in which first and second members are diffusion bonded to form a component with internal geometry. In the case of an airfoil shaped component (e.g., example fan blade 302 shown in FIG. 3B), the component can be provided with an initial airfoil shape and internal geometry as part of this step. In this example, a first airfoil member and a second airfoil member can be placed in a cavity of a diffusion bonding mold. The mold can correspond to the initial airfoil shape, which in certain embodiments, is a substantially flat shape characterized by a virtual absence of airfoil twist or camber. In other words, in such an embodiment, a camber line of the airfoil can be substantially collinear with the chord of the airfoil. In other embodiments, the camber line is not collinear but the camber angle of the initial airfoil shape can be less than or about 5°.

In certain embodiments, the first airfoil member can define one of a suction sidewall and a pressure sidewall, while the second airfoil member can define the other of the suction sidewall and the pressure sidewall. Thus a first side of each member can form an outer surface of the airfoil (i.e., the suction or pressure surface). A second opposing side of each member has at least one surface suitable to form at least part of an internal web, which may include one or more ribs. One example of such a component is best seen in FIG. 3B. The members can be formed by rolling, casting, forging, machining, or by a combination of these or other suitable metal working processes. The first and second members can be identical, symmetric, or asymmetric. In certain embodiments, at least one of the first and second airfoil members comprises a portion of a rolled metallic sheet.

The diffusion bonding process of step 102 can be any suitable known or inventive process used to join titanium or nickel alloy members into a finished component. At its simplest, a suitable diffusion bonding process will generally include placing the first and second members into a mold representing an initial shape. The mold and the enclosed members are heated under vacuum or inert atmosphere while pressure is hydraulically or otherwise applied laterally against the members to join surfaces of each member. Minimum temperatures for step 102, in the case of diffusion bonded conventional titanium alloys, can be at least about 700° C. (about 1290° F.), while minimum bond-specific pressure can be at least about 10 MPa (about 1450 psi).

In certain embodiments, the diffusion bonding process can also include super plastically forming at least one internal passage or cavity. Additionally or alternatively, internal passages can be formed at least in part by machining one or more surfaces of the members prior to bonding. The passages can be used to reduce the weight of the final product, or can provide internal passages for cooling air, or for other purposes.

After formation of a diffusion bonded component, either via step 102 or otherwise, the component can then be bulk shaped according to embodiments of method 100. In the case of fan blades or other airfoil shaped components, bulk shaping of a diffusion bonded component allows camber and/or twist to be added to an initially flat or nearly flat airfoil shape so as to provide the component with a target nominal airfoil shape. The component may be formed from symmetric or identical first and second airfoil members as part of step 102. After performing the remainder of method 100, the resulting highly twisted or cambered airfoil shaped components will generally have reduced passage and rib deformation as compared to those of previous forming techniques.

As used throughout, a “nominal” shape refers to a shape of the component at various stages of a forming or bulk shaping process. This includes but is not limited to initial, intermediate, or final nominal shapes, and thus does not account for any finish machining or other refining done before or after any bulk shaping steps.

Many airfoil designs can incorporate relatively high camber and/or twist particularly in the airfoil region so as to maximize efficiency in capturing the energy of working/combustion gases. However, to achieve a target nominal airfoil shape, a diffusion bonded component has traditionally been bulk-shaped directly from the initial shape using a single heated shaping die, which causes unpredictable distortion of internal passages and ribs. Use of asymmetric airfoil members has been used to provide some degree of initial camber to the initial airfoil shape. In other cases, the diffusion bonded airfoil has been cold-worked to add twist and/or camber just prior to placement in the single shaping die. However, these approaches can complicate the formation of the final airfoil, each adding substantial processing time before or after diffusion bonding.

Bulk shaping processes for a diffusion bonded component begin with step 104 in which the component having the initial shape is placed into at least a first intermediate shaping die. At step 106, a first elevated temperature is applied to the diffusion bonded component in the first intermediate shaping die. This is typically done while the die, corresponding to a first intermediate shape, applies a first intermediate shaping force to the component. The first elevated temperature and first intermediate shaping force provides the airfoil with a first intermediate shape different from the initial shape and a target nominal shape (see steps 108 and 110). Minimum temperatures for shaping step 106, in the case of a conventional titanium alloy, can be at least about 500° C. (about 930° F.).

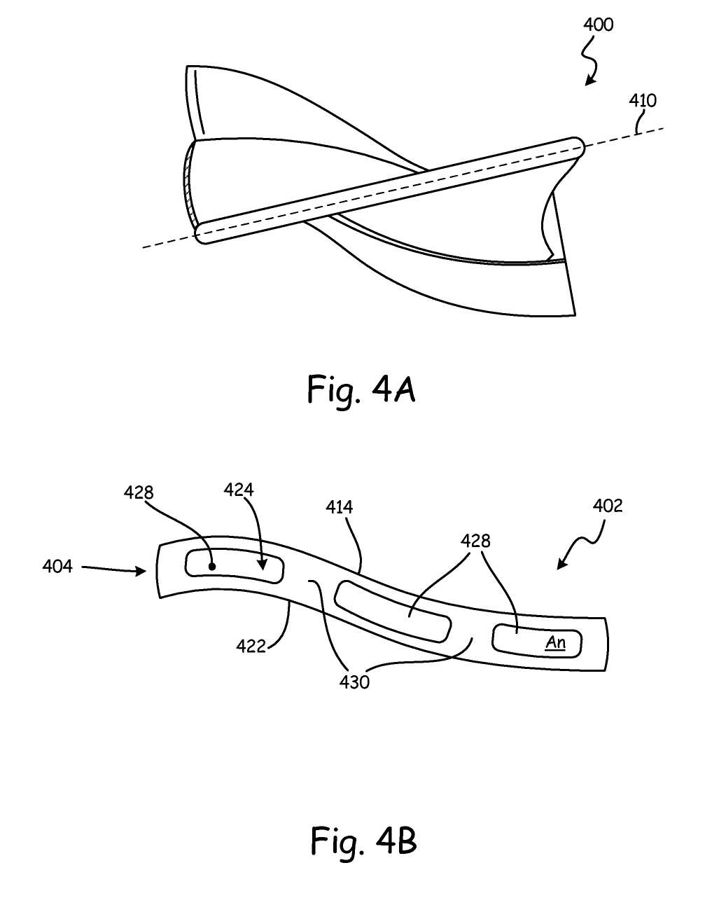

As an example of applying step 106 to airfoil shaped components, FIG. 4A shows a first intermediate shaping die for a diffusion bonded fan blade, while FIG. 4B is a sectional view of the resulting first intermediate airfoil shape. In certain embodiments, the first intermediate airfoil shape thus can have a first intermediate camber angle between an initial camber angle and a final or target nominal camber angle.

After formation of at least the first intermediate shape, the component is transferred into a final shaping die according to step 108. Step 110 then involves applying a final elevated temperature to the component in the final shaping die so as to provide the blade with a nominal shape substantially equivalent to the target nominal shape. Minimum shaping temperature for step 110, in the case of titanium alloys, can be similar to step 106, or at least about 500° C. (about 930° F.).

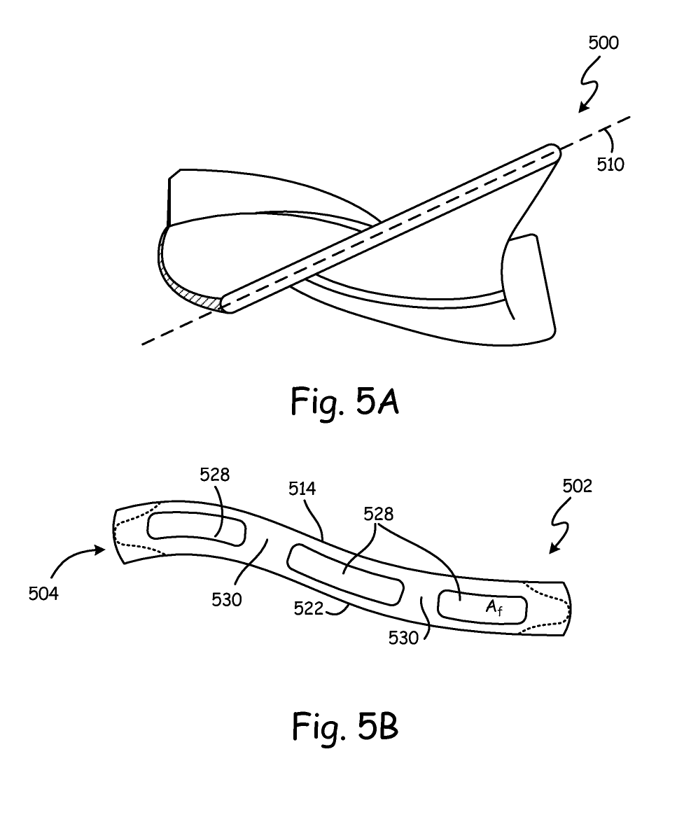

Finally, the component with a final nominal shape is processed according to step 112 which includes but is not limited to finish machining. In embodiments applied to airfoil shaped components, the resulting final nominal shape of the diffusion bonded airfoil component (i.e., the example fan blade) has at least one internal passage with a cross-sectional area substantially equivalent to a cross-sectional area of the internal passage with the airfoil component in its initial shape. This is best seen by comparing FIGS. 3B and 5B.

In many circumstances, method 100 can be performed with a single (i.e., a first) intermediate shaping die (step 104) and a corresponding first temperature and first pressure (step 106). However, it will be appreciated that steps 104 and 106 can include multiple (i.e., second and subsequent) iterations of intermediate shaping dies, temperatures, and/or pressures. For example, twist and camber can be added to the airfoil or other component in separate iterations of steps 104 and 106. Thus in certain embodiments, prior to step 108 of placing the component into a final shaping die, subsequent iterations of step 104 can include placing the component having the first intermediate shape into a second intermediate shaping die. In addition, iterations of step 106 can also involve a second elevated temperature being applied to the component in the second intermediate shaping die so as to provide the component with a second intermediate shape. The resulting second (and potentially subsequent) intermediate shapes are different from one another and from the initial shape, the first intermediate shape, and the target nominal shape.

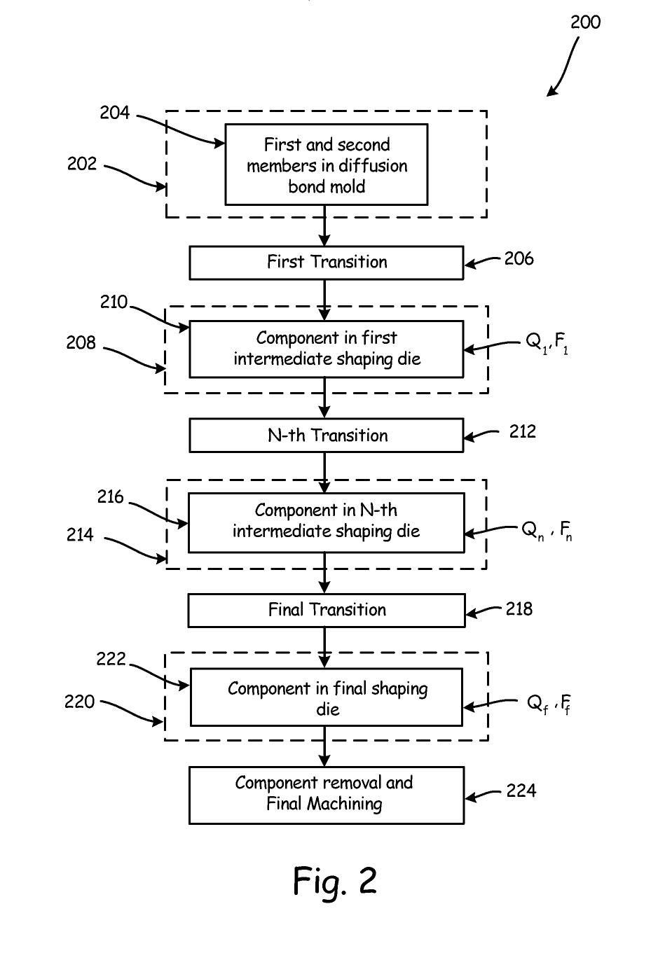

FIG. 2 schematically shows production system 200 for making and bulk shaping a component according to method 100. It will be appreciated that various aspects of production system 200 can be spread out in different locations and/or facilities. In one example, the diffusion bonding facilities are separate from bulk-shaping facilities. Production system 200 can include diffusion bonding unit 202 into which the first and second component members can be placed. Diffusion bonding unit 202 can be adapted to any suitable conventional or inventive diffusion bonding process. Example hardware for diffusion bonding unit 202 can include a furnace, a hydraulic or other mechanical press, as well as means for providing a vacuum or inert atmosphere to facilitate diffusion bonding processes. It will be recognized that certain embodiments of diffusion bonding unit 202 and/or diffusion bonding mold 204 will also be suitable for superplastic forming one or more passages (or precursors thereof) in the airfoil or other component.

In the airfoil example, first and second airfoil members can be cut from a casting or forging, which are then optionally machined to introduce spaces for starting or expanding internal airfoil cavities via superplastic deformation. First and second airfoil members are placed in diffusion bonding mold 204 and processed in diffusion bonding unit 202 to form an airfoil shaped component according to conditions suitable for the particular alloy and blade dimensions. The resulting component can have, for example, an initial airfoil shape that is substantially flat with at least one internal cavity or passage (best shown in FIG. 3B). At this stage, the flat airfoil may have substantially no twist and/or no camber in the airfoil section. In certain embodiments, a camber line of the airfoil is substantially collinear with the chord of the airfoil.

The airfoil or other diffusion bonded component is then transferred (in first transition region 206) from diffusion bonding mold 204 into a bulk shaping system with at least one intermediate shaping die received by at least one intermediate shaping unit (represented by first intermediate shaping die 210). Intermediate shaping die 210 applies a first shaping force F₁ while first intermediate shaping unit 208 applies a first heat Q₁ under vacuum or inert atmosphere. The component is thus formed into at least a first intermediate shape. In the example airfoil, first shaping force F₁ is applied with first heat Q₁ so as to introduce an intermediate twist and/or camber. The resulting airfoil can then have a first intermediate twist and/or first intermediate camber (best seen in FIG. 4B). Optionally, the bulk shaping system can include a location for transferring the component (e.g., n-th transition region 212) to additional n-th intermediate shaping die(s) 214. The component is transferred into subsequent intermediate shaping dies represented by n−1 intermediate shaping die 214. After application of n-th heat Qₙ via n-th intermediate shaping unit(s) 216 and the n-th intermediate shaping force Fₙ by each intermediate shaping die(s) 214, the component can be iteratively formed with subsequent n-th intermediate shape(s). Airfoils would thus be provided with corresponding intermediate twist and/or camber.

To complete bulk shaping, the airfoil or other component can then be transferred in final transition region 218 into final shaping die 220 applying a final shaping force F_{f}. The component with final shaping die 220 is exposed to final heat Q_{f} in final shaping unit 222. This results in the diffusion bonded component having a final shape substantially equivalent to the target nominal shape. Finally, the component is sent on to unit 224 for final processing, machining, etc.

FIG. 3A shows a top view of an example blade form 300, while FIG. 3B shows a sectional view of blade 302 taken chordwise through airfoil region 304. With reference to both FIGS. 3A and 3B, blade form 300 can be used to form blade 302 into its initial shape. Blade form 300 can be, for example, a diffusion bonding mold such as diffusion bonding mold 204 referenced in FIG. 2. In this example, blade 302 is a hollow fan blade with an internal geometry having one or more passages 328 separated by ribs 330. Here, blade form 300 can be a mold for joining together first airfoil member 306 and second airfoil member 308 to form blade 302 as shown. At this stage, blade 302, including airfoil section 304 is substantially flat with an initial twist and camber of approximately zero. In certain embodiments, first and second members 306, 308 begin as symmetric titanium alloy sheets. On one side of parting line 310, first airfoil member 306 has first (outer) side 312 generally corresponding to suction sidewall 314 and second (inner) side 315 generally corresponding to first web portion 316 in the finished blade 302. Similarly, on the other side of parting line 310, second airfoil member 308 has first (outer) side 318 corresponding generally to pressure sidewall 320 and second (inner) side 322 corresponding generally to second web portion 324. According to various known or inventive diffusion bonding and forming processes, first and second blade members 306, 308 can be joined along parting line 310 with respective first and second web portions 316, 324 forming at least one internal passage 328. Internal passages 328 can be separated from each other by rib(s) 330. Internal passages 328 can have an initial cross-sectional area A₀.

FIGS. 4A-4B and 5A-5B illustrate results of steps for bulk-shaping a diffusion bonded airfoiled component, such as blade 302 shown in FIG. 3B. Examples of a bulk-shaping process and system are described respectively in FIGS. 1 and 2. FIG. 4A shows a top view of intermediate blade form 400 with parting line 410, while FIG. 4B shows a sectional view of blade 402 taken chordwise through airfoil region 404. Blade 402 was originally a flat diffusion bonded blade (e.g., blade 302 in FIG. 3B) but is passed through at least one intermediate shaping die (e.g., intermediate blade form 400) and an intermediate shaping unit referenced in FIG. 2. Intermediate blade form 400 can be, for example, an intermediate shaping die such as first intermediate shaping die 216 and/or one of the n-th intermediate shaping dies 222 referenced in FIG. 2.

Blade 402 has curved suction sidewall 414 and curved pressure sidewall 422 connected by web 424 with at least one internal passage 428 separated by rib(s) 430. Blade 402 in FIG. 4B is no longer flat (see blade 302 in FIG. 3A), and now has intermediate twist which is less than a final twist. Internal passages 428 substantially maintain a wide cross-sectional area Aₙ relative to area A₀ of blade 302 as shown in FIG. 3A.

FIG. 5A shows a top view of example final blade form 500, while FIG. 5B shows a sectional view of blade 502 taken chordwise through airfoil region 504. Blade 502 originated as flat blade 302 prior to application of a bulk shaping process described above, in which the airfoil shape was converted to at least one intermediate airfoil shape to form blade 402 with a corresponding intermediate airfoil shape. Blade 502 has highly curved suction sidewall 514 and highly curved pressure sidewall 522 connected by web 524 with at least one internal passage 528 separated by rib(s) 530. Blade 502 is now substantially in a final shape, and internal passages 528 substantially maintain a wide cross-sectional area A_{f} relative to areas Aₙ and A₀ (See FIGS. 3B and 4B). The cross-sectional area can be characterized in different ways depending on the overall airfoil shape. However, one possible means of comparing the deformation of internal passages 528 relative to passages 328 (shown in FIG. 3B) can include the relative dimension of the internal passages in the airfoil thickness direction. The relative thickness dimensions of the internal passages can be taken as an average, a minimum, or other suitable comparison.

As noted above, changing the camber and twist of a generally flat diffusion bonded airfoiled component typically has been done by placement of the airfoiled component into a single shaping die corresponding to the final target shape. High levels of torsion or twist applied to achieve high degrees of camber and/or twist, with or without heat, can deform the sidewalls and/or internal ribs, thereby narrowing one or more of the passages in the finished airfoil. The unpredictable nature of this process causes high correction and scrap rates.

In contrast, a flat (or nearly flat) diffusion bonded airfoiled component with minimal twist and small camber angles can be sent through a bulk shaping process, embodiments of which are described above. By utilizing at least one intermediate hot-forming process and corresponding intermediate shaping die(s) prior to the final shaping die, process repeatability and success rates can be improved.

Although the present invention has been described with reference to preferred embodiments, workers skilled in the art will recognize that changes may be made in form and detail without departing from the spirit and scope of the invention.

1. A method for making a metallic component, the method comprising:
placing a diffusion bonded component having an initial shape into a first intermediate shaping die, the first intermediate shaping die having a cavity corresponding to a first intermediate shape different from the initial shape;
shaping the component into the first intermediate shape by applying a first elevated temperature to the first intermediate shaping die;
placing the component into a final shaping die having a cavity corresponding to a target nominal shape, the target nominal shape different from the first intermediate shape and the initial shape; and
shaping the component into a final nominal shape substantially equivalent to the target nominal shape by applying a final elevated temperature to the final shaping die.

2. The method of claim 1, wherein the component is selected from one of: a component with internal geometry and an airfoil shaped component with internal geometry.

3. The method of claim 2, wherein the component is an airfoil shaped component with internal geometry.

4. The method of claim 3, wherein the initial shape is an initial airfoil shape with a camber line substantially collinear to a chord of the initial airfoil shape.

4(1). (canceled)

5. The method of claim 3, wherein at least one of the shaping steps comprises:
increasing a twist of the airfoil shaped component.

6. The method of claim 3, further comprising:
diffusion bonding a first airfoil member and a second airfoil member to form the airfoil shaped component.

7. The method of claim 6, wherein the diffusion bonding step comprises:
placing a first airfoil member and a second airfoil member into a diffusion bonding mold having a mold cavity corresponding to the initial airfoil shape; and
heating the first and second airfoil members to a temperature equal to or greater than a minimum diffusion bonding temperature.

8. The method of claim 7, wherein the first airfoil member comprises one of: a suction sidewall and a pressure sidewall; and the second airfoil member comprises the other of: the suction sidewall and the pressure sidewall.

9. The method of claim 8, wherein the diffusion bonding step further comprises:
superplastically forming at least one internal passage in the airfoil shaped component.

10. The method of claim 3, wherein the airfoil shaped component is a fan blade for a turbofan engine.

11. The method of claim 1, further comprising:
prior to placing the component into the final shaping die, placing the component having the first intermediate shape into a second intermediate shaping die.

12. The method of claim 11, further comprising:
shaping the component into a second intermediate shape by applying a second elevated temperature to the second intermediate shaping die.

13. The method of claim 12, wherein the second intermediate shape is different from the initial nominal shape, the first intermediate shape, and the target nominal shape.

14. The method of claim 1, wherein the component comprises one of: a titanium alloy and a nickel alloy.

15. A system for processing a metallic component, the system comprising:
a first intermediate shaping die adapted to receive a diffusion bonded metallic component having an initial shape and an internal geometry;
a first intermediate shaping unit adapted to facilitate a first stage of a bulk shaping process by receiving and elevating the temperature of the first intermediate shaping die;
a final shaping die adapted to receive the metallic component after the first stage of the bulk shaping process; and
a final shaping unit adapted to facilitate a final stage of the bulk shaping process by receiving and elevating the temperature of the final shaping die.

16. The system of claim 15, wherein the first intermediate shaping die has a cavity corresponding to a first intermediate shape different from the initial shape.

17. The system of claim 16, wherein the final shaping die has a cavity corresponding to a target nominal shape, the target nominal shape different from the first intermediate shape and the initial shape.

18. The system of claim 15, wherein the metallic component is an airfoil shaped component with internal geometry.

19. The system of claim 18, wherein the initial shape is an initial airfoil shape with a camber line substantially collinear to a chord of the initial airfoil shape.

20. The system of claim 19, wherein the first intermediate shape is a first intermediate airfoil shape with a larger camber angle than a camber angle of the initial airfoil shape.

21. The system of claim 20, wherein the target nominal shape is a target nominal airfoil shape with a larger camber angle than a camber angle of the first intermediate airfoil shape.

22. The system of claim 18, wherein the airfoil shaped component is a fan blade for a turbofan engine.

23. The system of claim 18, further comprising:
a diffusion bonding unit adapted to join a first airfoil member and a second airfoil member to form the airfoil shaped component.

24. The system of claim 23, wherein the diffusion bonding unit comprises:
a diffusion bonding mold adapted to receive a first airfoil member and a second airfoil member into a mold cavity.

25. The system of claim 24, wherein the diffusion bonding unit is adapted to heat the first and second airfoil members to a temperature equal to or greater than a minimum diffusion bonding temperature.

26. The system of claim 15, further comprising:
a second intermediate shaping die adapted to receive the component having the first intermediate shape; and
a second intermediate shaping unit adapted to facilitate a second stage of the bulk shaping process by receiving and elevating the temperature of the second intermediate shaping die.

27. The method of claim 3, wherein at least one of the shaping steps comprises:
increasing a camber angle of the airfoil shaped component.
